(19) United States
(12) Patent Application Publication
(10) Pub. No.: US 2002/0011773 A1
(43) Pub. Date: Jan. 31, 2002

(54) Deflection yoke apparatus

(75) Inventors: Yusuke Chonan, Oyama-shi (JP); Keiji Morimoto, Oyama-shi (JP)

Correspondence Address: Connolly Bove Lodge & Hutz LLP, Suite 800, 1990 M Street, N. W., Washington, DC, 20036-3425, US

(73) Assignee: VICTOR COMPANY OF JAPAN, LIMITED, Yokohama-shi (JP)

(21) Appl. No.: 09/841,124

(22) Filed: Apr. 25, 2001

(30) Foreign Application Priority Data
Apr. 25, 2000 (JP) 2000-124086

(51) Int. Cl. H01J 29/70

(52) U.S. Cl. 313/440

(57) ABSTRACT

A neck portion (3) formed in the subterminal portion of the narrower diameter side of the funnel shaped separator, has holding portions (32a, 32b) and upper holding portion (33a, 33b) to hold magnetic rings (10, 11, 20, 21). The protrusions (80a, 80b) formed in the neck portion (3) have slope side (80a1, 80b1). Upon the insertion of the magnetic rings (10, 11, 20, 21) to the neck portion (3) from the narrower diameter side thereof, the magnetic rings (10, 11, 20, 21) contact the slope sides (80a1, 80b1) before they contact the slope sides (33a2, 33b2) of the protrusions (33a0, 33b0) of the upper holding portion (33a, 33b).

### BACKGROUND OF THE INVENTION

1. Field of the Invention

The present invention relates to a deflection yoke used with an in-line type cathode ray tube (CRT), and particularly relates to a deflection yoke for adjusting a characteristic of a magnetic field, such as convergence or purity, by rotating a multipolar magnetic ring mounted on a cylindrical neck portion of such deflection yoke.

2. Description of the Related Art

Generally, a deflection yoke used with an in-line type CRT, has a multipolar, for example, dipole or quadrupole magnetic ring. The multipolar magnetic ring is used for adjustment of a magnetic field characteristic such as convergence or purity of a CRT by tuning a position of such the multipolar magnetic ring.

FIG. 8 is a perspective view for explaining an example of a deflection yoke for a CRT. In FIG. 8, the deflection yoke comprises a pair of separators 1a and 1b made by an insulating material, a pair of horizontal deflection coils (not shown) in inside of the deflection yoke, a pair of vertical deflection coils 7 on the outside of the deflection yoke, and a pair of cores 2 on the outer side of the vertical deflection coil 7. A flange if is formed in a narrower diameter side of the first separator 1a and the second separator 1b, and a cylindrical neck portion 103 is formed in the flange 1f. A clamp band 5 with a screw 6 is loaded on the upper portion of the neck portion 103 to stabilize deflection yoke on to CRT.

FIG. 9 is a partial perspective view for explaining the example of the deflection yoke shown in FIG. 8. In FIG. 9, the cylindrical neck portion 103 having tongues 103a through 103f, is formed on a flange 1f with the first and second separators 1a and 1b.

The cylindrical neck portion 103 is inwardly flexible as it has slits 104a through 104f. A clamp band 5 for fixing the deflection yoke to a neck of the CRT is provided on the upper side of the neck portion 103. The screw 6 is screwed to the clamp band 5, and fastens the deflection yoke to the neck of the CRT by tightening the clamp band 5 about the neck portion 103. A prominence 14 is formed on the upper portion of tongues 103c and 103f to fit with a pair of hole 5a and 5b formed in the clamp band 5. The prominence 14 has a slope in downward direction for leading the holes 5a and 5b to make the clamp band 5 easily fit with the neck portion 103. The clamp band 5 with a screw 6 is loaded on the upper portion of the neck portion 103 to stabilize the deflection yoke on to the CRT.

A magnetic ring 10 and a magnetic ring 11 having a multipolar magnet respectively are provided between the clamp band 5 and the flange 1f of the first and second separators 1a and 1b. FIG. 9 shows the clamp band 5 and the magnetic rings 10 and 11 being removed from the neck portion 103. Generally, the magnetic rings 10 and 11 comprise material dispersed with magnetic powder such as barium ferrite or the Alnico alloy substance evenly on a nylon plastic. As the magnetic ring has variety in size at manufacturing, the inner diameter of the magnetic rings 10 and 11 is 0.4 mm wider at maximum than the outer diameter of the neck portion 103, in order to avoid the magnetic ring being tightfitting with the neck portion 103.

More precisely, protrusions 12a and 12b are provided at the bottom of the neck portion 103, and are flexible in the longitudinal direction of the neck of the CRT (i.e. the direction of a Z axis). A hook 13 having a claw 13a of triangular shape at their distal ends are formed in the tongues 103c and 103f of the neck portion 103. The magnetic rings 10 and 11 are inserted from the rear side of the deflection yoke, about the neck portion 103 between the protrusions 12a and 12b, and the claw 13a.

FIG. 10 is a cross-sectional view of the neck portion 103 along with the direction of the Z axis. An edge side 13a1 of the claw 13a is almost orthogonal with the Z axis and a sloped side 13a2 of the claw 13a stick out with length d1 which is about 1.3 mm long enough to hold the magnetic ring being attached between the protrusions 12a and 12b, and the claw 13a. An outer side 13a3 of the claw 13a is provided to maintain the strength of metal mold for molding the separators 1a and 1b. The outer side 13a3 is almost parallel to the Z axis and has length of approximately 0.3 mm.

Recently, there has been a need for small display monitor using CRT in the market. In order to provide such a small display, the length of CRT and the deflection yoke is required to be shorter. For this reason, the distance between the bottom side of the clamp band 5 and the bottom side of magnetic rings attached to the neck portion 103 is required to be shorter, and the length of the claw 13a in the direction of Z axis is required to be 1.3 mm at maximum. Under circumstance, the length of each side of the claw 13a should be set to make slope angle θ of the slope side 13a2 bigger so that the magnetic rings can be easily attached to the neck portion 103.

A slope side 13a2s is a start position of the slope for the slope side 13a2. The slope side 13a2s is not set to the position coming out of the outer diameter side of the neck portion 103 but contiguous the outer diameter portion of the neck portion 103. The slope angle θ, for example, is 32 degrees. The reason why the slope side 13a2s does not start from the inner diameter side of the neck portion 103 (and the reason why the claw 13a has the edge side 13a1) is because the slope angle θ will be maximum at this position.

As the magnetic rings 10 and 11 are inserted to the neck portion 103 from the narrower diameter side of the deflection yoke, the magnetic rings 10 and 11 contact the prominence 14 and the neck portion 103 flex inwardly to let the magnetic rings 10 and 11 pass through the prominence 14. Then the magnetic rings 10 and 11 contact the slope side 13a2 and the tongue 13 flex inwardly. Eventually, the magnetic rings 10 and 11 are held between the protrusions 12a and 12b, and the claw 13a. The distance between the protrusions 12a and 12b, and the claw 13a is lesser than the thickness of the magnetic rings 10 and 11 so that the bounce force of the protrusion 12a and 12b holds the magnetic rings 10 and 11.

The adjustment of a characteristic of a magnetic field of CRT can be accomplished by putting a deflection yoke on the CRT and rotating the magnetic rings 10 and 11. The magnetic rings can be rotate at an appropriate torque (not too tight or not too loose) by the protrusions 12a and 12b, and the claw 13a holding the magnetic rings 10 and 11 so that the magnetic rings 10 and 11 can not easily rotate before they are being fixed with a glue after the adjustment. This torque is also caused by the bounce force of the protrusions 12a and 12b in the direction of the Z axis.

FIG. 11 is a cross-sectional view of the tongues 103f and 103c of the neck portion 103 along with the direction of the Z axis where the magnetic ring 11 is being inserted. When the magnetic rings 10 and 11 is inserted in the neck portion 103 by hands, the magnetic ring 11 will occasionally be pushed to the direction shown as an arrow A in FIG. 11 which is the direction orthogonal to the Z axis. Then the tongue 103f flexes inwardly from the position shown in a dotted line. At this position, the inner circumference side of the magnetic ring 11 contacts the edge side 13a1 of the claw 13a.

This will cause the insertion of magnetic ring 11 to the neck portion 103 difficult. Too much strength to insert the magnetic ring 11 in the neck portion 103 at this position may break the magnetic rings 10 and 11. As explained above, the magnetic rings 10 and 11 may break in the way of inserting.

### SUMMARY OF THE INVENTION

Accordingly, in consideration of the above-mentioned problem of the related art, an object of the present invention is to provide a deflection yoke of which a magnetic ring is attached to the neck portion, to control convergence by tuning such magnetic ring, and which can prevent a magnetic ring from being disengaged from a neck portion without losing smooth attachment to the neck portion.

In order to achieve the above object, the present invention provides, according to an aspect thereof, a deflection yoke apparatus including neck portion (3) in a cylindrical shape formed on a subterminal portion of a funnel shaped separator having a narrower diameter portion and a wider diameter portion, a magnetic ring (10, 11, 20 and 21) rotatably mounted on the neck portion (3), a holding portion (33a, 33b) for holding the magnetic ring from the narrower diameter portion side; and a protrusion (80a, 80b, 81) formed on the neck portion having a first slope surface (80a1, 80b1) decline to the outer direction from the narrower diameter portion side to the wider diameter portion side of the neck portion, wherein the magnetic ring contacts the first slope surface before contacting the holding portion when the magnetic ring is inserted to the neck portion from the narrower diameter portion side, and the protrusion leads the magnetic ring to the holding portion.

Other objects and further features of the present invention provides the deflection yoke as mentioned above, wherein the holding portion (33a, 33b) has a second slope surface (33a0, 33b0) decline to the outer direction from the narrower diameter portion side to the wider diameter portion side of the neck portion (3), and the first slope surface (80a1, 80b1) of the protrusion leads the magnetic ring to the second slope surface of the holding portion.

Other objects and further features of the present invention provides the deflection yoke including neck portion (3) having a cylindrical shape and formed on a subterminal portion of a funnel shaped separator with a narrower diameter portion and a wider diameter portion, first protrusion (14) formed on the neck portion, clamp band (5) having a hole to fit with the first protrusion, for being attached to and for tightening up the neck portion, magnetic ring rotatably mounted on the wider diameter portion side of the neck portion than the position of the clamp band being attached to the neck portion, holding portion (33a, 33b) for holding the magnetic ring from the narrower portion side; and second protrusion (80a, 80b, 81) having a slope surface decline to the outer direction from the narrower diameter portion side to the wider diameter portion side of the neck portion, and formed on the neck portion between the first protrusion and the holding portion, wherein the magnetic ring being inserted to the neck portion contacts the slope surface before contacting the holding portion.

A deflection yoke incorporating the principles of the present invention will be described in detail with reference to the accompanying drawings, in which the same reference numerals and symbols are used to denote like or equivalent elements used in the aforementioned prior art deflection yoke, and the detailed explanation of such elements are omitted for simplicity.

### BRIEF DESCRIPTION OF DRAWINGS

FIG. 1 is a perspective view of a deflection yoke according to a first embodiment of the present invention.

FIG. 2 is a partial perspective view of a deflection yoke shown in FIG. 1 according to the present invention.

FIG. 3 is a partial perspective view of a substantial portion of a deflection yoke according to the first embodiment of the present invention.

FIG. 4 is a cross-sectional view of a substantial portion of a deflection yoke shown in FIG. 3.

FIG. 5 is a cross-sectional view of a substantial portion of a deflection yoke for explaining a clamp band and a magnetic ring being inserted in a deflection yoke according to the present invention.

FIG. 6 is a cross-sectional view of a substantial portion of a deflection yoke for explaining an insertion of a magnetic ring to a deflection according to the present invention.

FIG. 7 is a partial perspective view of a substantial portion of a deflection yoke according to a second embodiment of the present invention.

FIG. 8 is a perspective view of a deflection yoke according to the prior art.

FIG. 9 is a partial perspective view of a deflection yoke according to the prior art.

FIG. 10 is a cross-sectional view of a deflection yoke for explaining the prior art.

FIG. 11 is a cross-sectional view of a deflection yoke for explaining the prior art.

### DETAILED DESCRIPTION OF THE PREFERRED EMBODIMENTS

[First Embodiment]

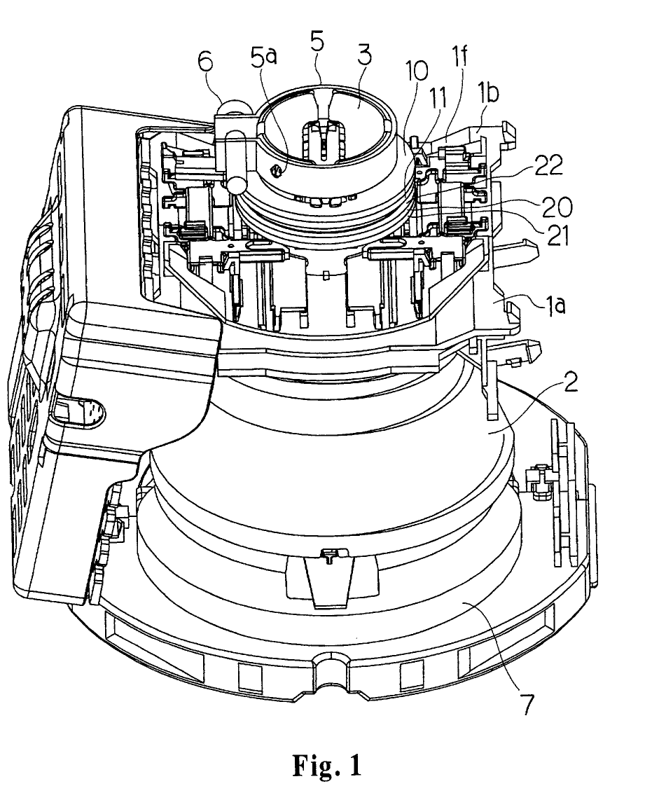

FIG. 1 is a perspective view of a deflection yoke according to the present invention. In FIG. 1, a deflection yoke for a CRT comprises a pair of separator 1a and 1b made by an insulating material to form an infundibular shape, a pair of horizontal deflection coils (not shown) in an inner side of the deflection yoke, a pair of vertical deflection coils 7 in outer side thereof, a pair of cores 2 in outer side of the vertical deflection coil 7, a flange If on a minor diameter side of the separators 1a and 1b with a cylindrical neck portion 3, forming on the flange 1f. There also provided a clamp band 5 on the neck portion 3, and the clamp band 5 comprises a hole 5a in its ring portion and a screw 6. The deflection yoke also comprises a pair of magnetic rings 10 and 11 and another pair of magnetic rings 20 and 21 to control the magnetic characteristic of the deflection yoke, and a spacer ring 22 between each pair of magnetic rings 10, 11 and 20, 21.

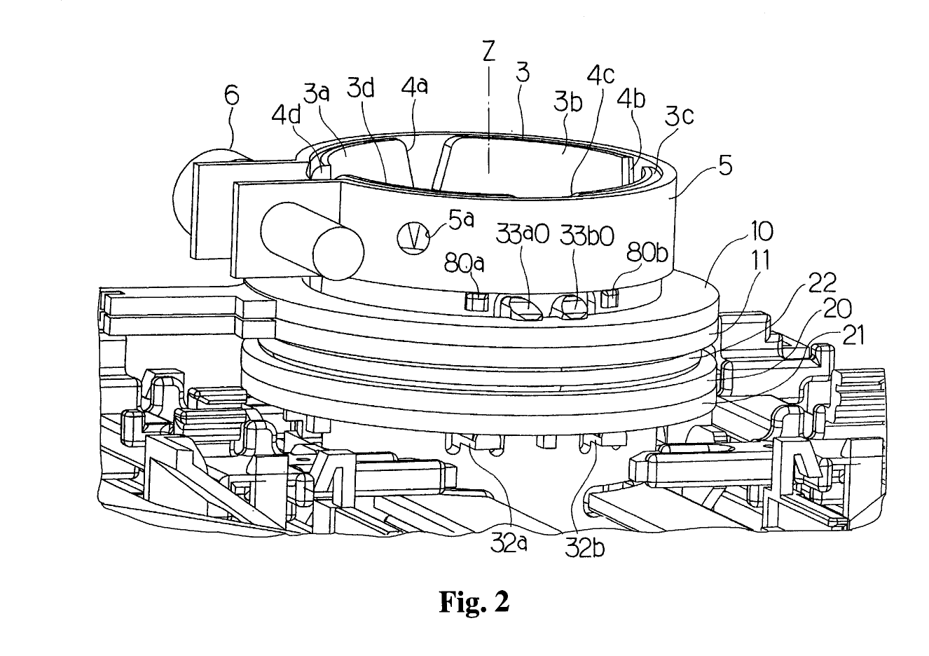

FIG. 2 is a partial perspective view of the deflection yoke shown in FIG. 1 according to the present invention. The neck portion 3 has a cylindrical shape with tongues 3a through 3d and is formed on the flange 1f with a pair of separators 1a and 1b. The neck portion 3 is not limited to have four tongues that it may have six tongues as described in the prior art and more or less. The neck portion 3 is flexible inwardly by a plural of slits 4a through 4d formed on thereof. The clamp band 5 is attached to the neck portion 3 to stabilize the deflection yoke on a neck portion of a CRT. The clamp band 5 has a hole 5a on its ring portion to fit with a prominence (not shown) formed on the side of neck portion 3. The screw 6 tighten an inner circumference of the clamp band 5 as it screws to stabilize the deflection yoke on the neck portion of the CRT.

The magnetic rings 10, 11, 20 and 21 are attached to the neck portion 3 between the clamp band 5 and flange if with separators 1a and 1b. The spacer ring 22 is inserted unrotatablly between each pair of magnetic rings 10, 11 and magnetic rings 20, 21 to make each pair of magnetic rings rotate independently. The magnetic rings 10, 11, 20 and 21 comprise of material dispersed with magnetic powder such as barium ferrite or the Alnico alloy substance evenly on a nylon plastic. There provided an upper holding portions 33a0 and 33b0, and holding portions 32a and 32b on the side of neck portion 3 to hold the magnetic rings 10, 11 and 20, 21, and there also provided a protrusion 80a and 80b between the clamp band 5 and magnetic rings 10 and 11. Z axis shown in FIG. 2 is identical to the coaxial axis of the CRT to which the neck portion 3 is attached.

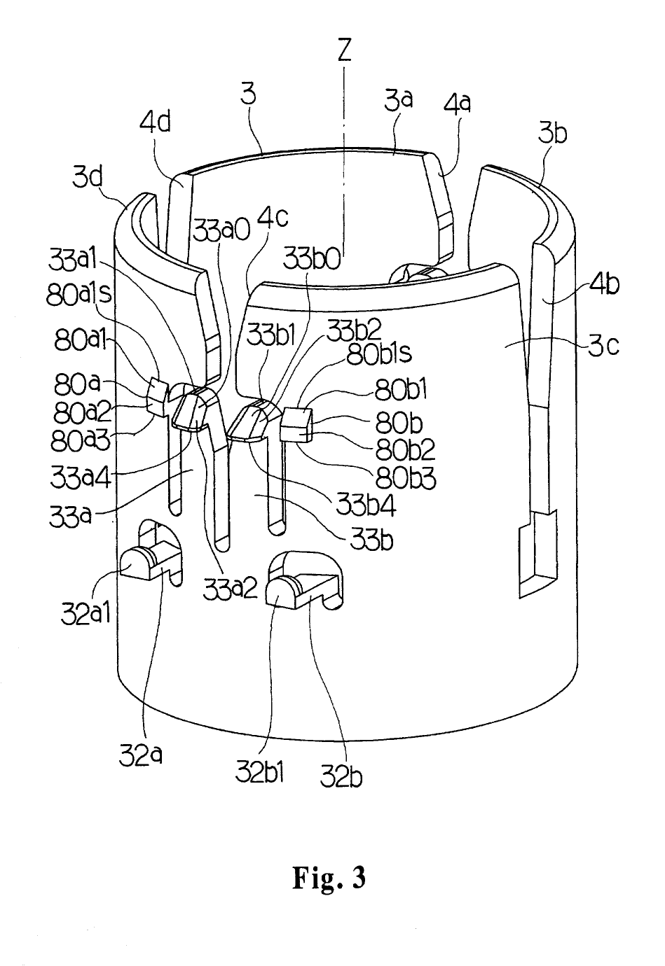

FIG. 3 is a partial perspective view of a substantial portion of a deflection yoke according to the first embodiment of the present invention. There provided holding portions 32a and 32b in the bottom portion of the center of neck portion 3 with tongues 3d and 3c. The holding portions 32a and 32b are formed in arm shape and flexible to the direction parallel to the Z axis. The edge portion of holding portion 32a has a protrusion 32a1 and the edge portion 32b has a protrusion 32b1 in the upward direction. There also provided a holding portion similar to the holding portions 32a and 32b in the opposite side of the neck portion 3 with tongues 3a and 3b.

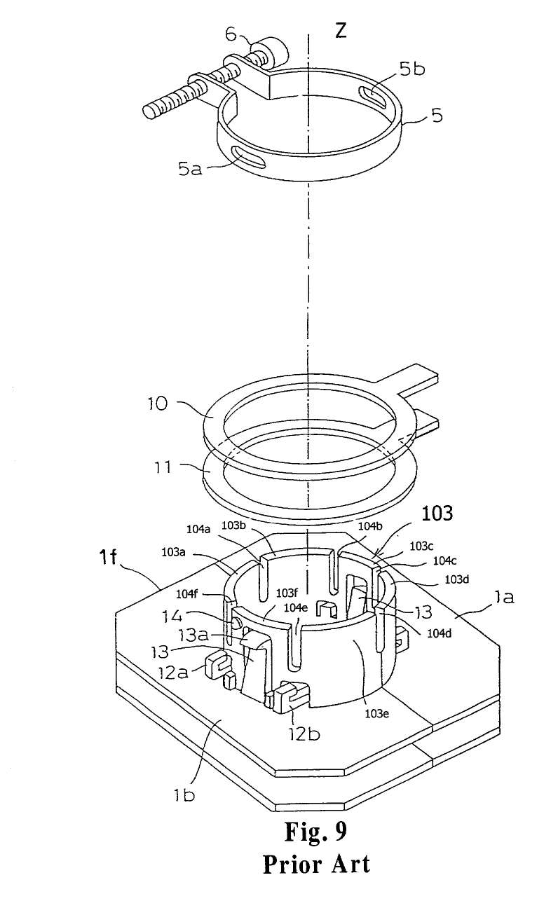

The neck portion 3 comprises L-shaped upper holding portions 33a and 33b. The upper holding portions 33a and 33b are connected with tongues 3c and 3d, and they are substantially independent portions. The upper holding portions 33a and 33b have substantially the same function of the tongue 13 shown in FIG. 9. The edge portion of each upper holding portion 33a and 33b has claw shaped protrusions 33a0 and 33b0. The protrusions 33a0 and 33b0 have edge surface 33a1 and 33b1 respectively, which surface is orthogonal with the Z axis. Slope surfaces 33a2 and 33b2 are the prominent surface of the upper holding portions 33a and 33b in outer side of the neck portion 3, and each surface 33a4 of the protrusion 33a0 and surface 34b4 of the protrusion 33b0 is opposed to the holding portions 32a and 32b respectively, each of which is orthogonal with the Z axis. The slope surfaces 33a2 and 33b2 have a downslope from the edge surface 33a1 and 33b1 towards the direction of holding portions 32a and 32b. More precisely, the slope surfaces 33a2 and 33b2 decline to the outer side towards the direction of the narrower diameter portion of the infundibular shaped deflection yoke to the wider diameter portion thereof.

The upper holding portions 33a and 33b, except for the protrusions 33a0 and 33b0, are placed in substantially the same circumference of the neck portion 3, There also provided an upper holding portion similar to the upper holding portion 33a and 33b on the opposite side of the tongues 3d and 3c. The upper holding portions 33a and 33b, and the holding portions 32a and 32b hold the magnetic rings 10, 11, 20 and 21.

In FIG. 3, there provided protrusions 80a and 80b with rib shape on the tongues 3c and 3d. There also provided a rib shaped protrusion similar to the protrusions 80a and 80b on the tongues 3a and 3b. The protrusion 80a and 80b are formed on the position lower (i.e. the side of wider diameter portion of the deflection yoke) than the position where the clamp band 5 is attached to the neck portion 3, and contiguous the protrusion 33a0 and 33b0.

Each protrusion 80a and 80b has a slope surface 80a1 and 80b1 of which slope starts from a position 80a1s and 80b1s respectively, and inclines to the outer side towards the direction of the holding portions 32a and 32b. Each slope surface 80a1 and 80b1 is connected with an outer surface 80a2 and 80b2 respectively, and side surfaces 80a3 and 80b3 are connected with the outer surfaces 80a2 and 80b2 respectively, in the position opposed to the holding portion 32a and 32b.

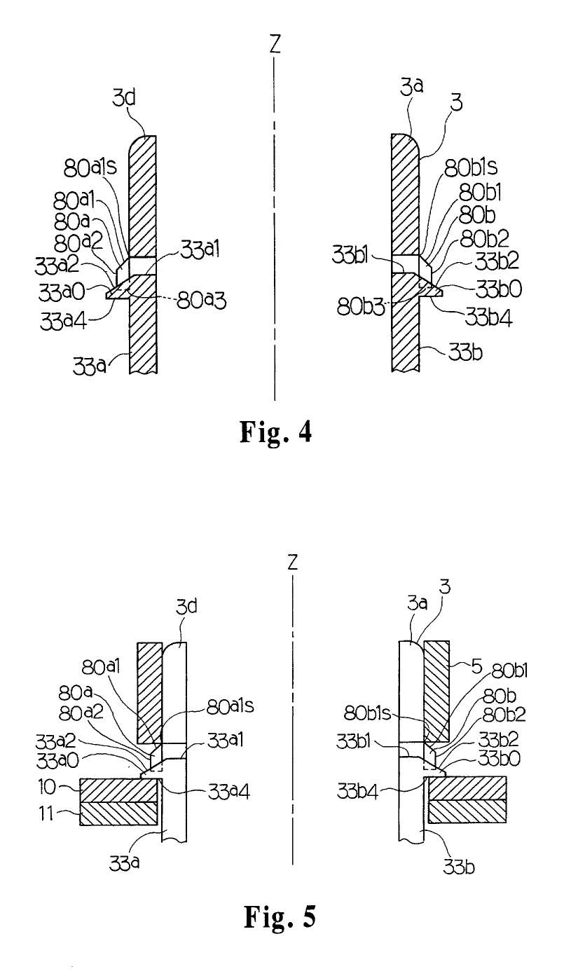

FIG. 4 is a cross-sectional view of the tongues 3a and 3d of the neck portion 3 towards the direction parallel to the Z axis. The protrusions 80a and 80b are formed in the upper position (the position towards the wider diameter portion side of the deflection yoke) than the protrusions 33a0 and 33b0 of the upper holding portions 33a and 33b.

FIG. 5 is a cross-sectional view of the tongues 3a and 3d of the neck portion 3 shown in FIG. 4 where the clamp band 5 and the magnetic rings 10 and 11 are inserted on the neck portion 3. In FIG. 5, the bottom portion side (i.e. towards the direction of wider diameter portion of the deflection yoke) of the clamp band 5 stops at the start position 80a1s and 80b1s when the clamp band 5 is inserted in the neck portion 3. The slope surfaces 80a1 and 80b1 are formed in the upper position than the slope surfaces 33a2 and 33b2.

The protrusions 80a and 80b should be in a position where the slope surfaces 80a1 and 80b1 contact the magnetic rings 10 and 11 before they contact the slope surfaces 33a2 and 33b2 of the protrusions 33a0 and 33b0 when they are inserted in the neck portion.

The magnetic rings 10 and 11 should be held by the upper holding portions 32a and 32b, and the holding portions 33a and 33b. Accordingly, the side surfaces 80a3 and 80b3, and the surfaces 33a4 and 34b4 should be in the same surface orthogonal to the Z axis or the side surfaces 80a3 and 80b3 should be in the position nearer to the narrower diameter portion side of the deflection yoke than the surfaces 33a4 and 33b4.

The outer side surfaces 80a2 and 80b2 are formed in the same circumference and the outer side of protrusions 33a0 and 33b0 are formed in the same circumference. The diameter of circumference for the outer side surfaces 80a2 and 80b2 is shorter than the diameter of circumference for the outer side of protrusions 33a0 and 33b0. The diameter of circumference for the outer side surfaces 80a2 and 80b2 is bigger than the inner circumference of the magnetic rings 10, 11, 20 and 21.

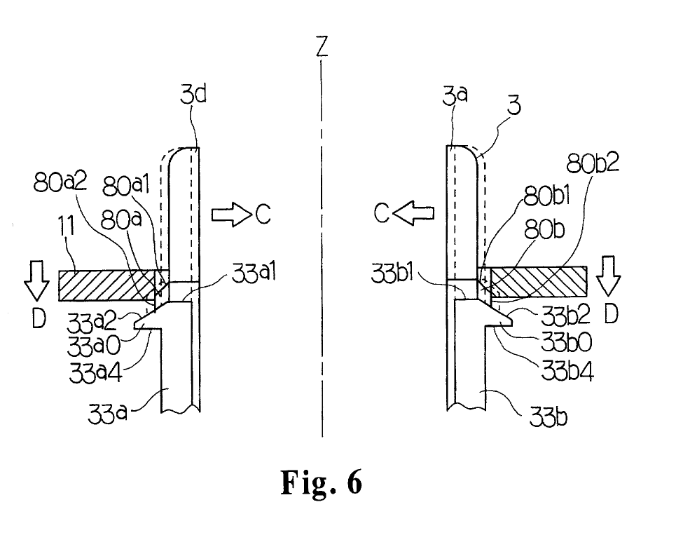

FIG. 6 is a cross-sectional view of a substantial portion of a deflection yoke for explaining an insertion of a magnetic ring to a deflection yoke according to the present invention. As the magnetic ring 11 is inserted to the neck portion 3, the magnetic ring 11 passes through the prominence 14 (not shown in FIG. 6) and comes to the position shown in FIG. 6. As the inner circumference of the magnetic ring 11 is shorter than the circumference of the outer side surfaces 80a2 and 80b2, the magnetic ring 11 contacts the slope surfaces 80a1 and 80b1. As the magnetic ring 11 moves to the direction D (shown as an arrow D), the tongues 3c and 3d (and tongues 3a and 3b) flex inwardly (to the direction shown as an arrow C) from the position shown in a dotted line to the position shown in a solid line. As the tongues 3a through 3d flex equally, the position of the magnetic ring 11 is set on the center of the neck portion 3. The insertion of the magnetic rings 10, 20 and 21 operates in exactly same manner.

As the magnetic ring 11 is inserted towards the direction D, the magnetic ring 11 contact the protrusions 80a and 80b, and then contact the slope sides 33a2 and 33b2. As the magnetic ring 11 is further inserted to the direction D, the holding portions 33a and 33b flex inwardly to the direction C, and it overcomes the protrusions 33a0 and 33b0. Consequently, the magnetic ring 11 is inserted between the protrusions 33a0 and 33b0 of the upper holding portions 33a and 33b, and the holding portions 32a and 32b.

The magnetic rings 10, 20 and 21 are inserted to the neck portion 3 as described above. As the pushing force is added to the neck portion 3 to the direction C, the bounce force pushes back the protrusions 80a and 80b to keep the center of magnetic rings 10, 11, 20 and 21 in the coaxial center of the neck portion 3. Further, the protrusions 80a and 80b induce the magnetic rings to contact the slope side 33a2 and 33b2 of the upper holding portions 33a and 33b.

Consequently, even when the tongues 3a through 3d flex, the magnetic rings 10, 11, 20 and 21 do not contact the edge surfaces 33a1 and 33b1 of the upper holding portions 33a and 33b, but contact the edge surfaces 33a1 and 33b1. This gives simple and easy way to attach the magnetic rings 10, 11, 20 and 21 on the neck portion 3. In addition, the magnetic rings 10, 11, 20 and 21 will not break since they do not contact the edge surfaces 33a1 and 33b1 and stuck on the position.

Further more, the protrusions 80a and 80b induce the clamp band 5 to the appropriate position and restrict the position towards the direction of the Z axis. Even if the clamp band 5 contact the slope surfaces 80a1 and 80b1 before tightening up the bolt 6, the clamp band 5 will slip the slope surfaces 80a1 and 80b1 to the direction towards the neck as the bolt 6 is being tightening up. Eventually, the clamp band 5 is induced to the position 80a1s and 80b1s as shown in FIG. 5.

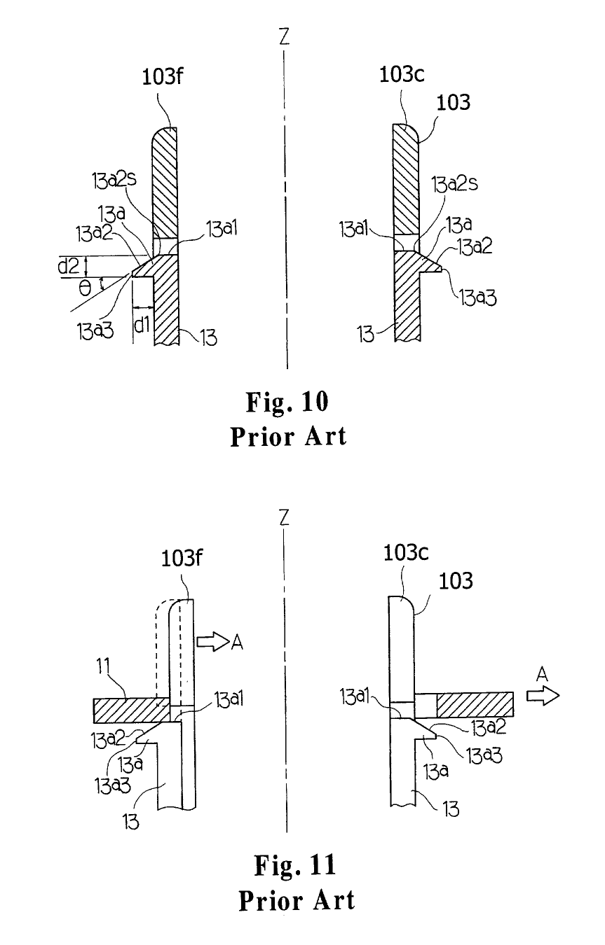

In addition, as the clamp band 5 does not contact the protrusions 33a0, 33b0 when the clamp band 5 is tightened up, the slope angle of the slope sides 33a2 and 33b2 (equivalent to the slope angle θ shown in FIG. 10) can be increased to make the insertion of the magnetic rings 10, 11, 20 and 21 easier.

The present invention is not limited to the embodiment described above and can be modified in various ways. The protrusions 80a and 80b can be formed in any place as long as the physical relationship between the protrusion 80a and 80b, and the protrusions 33a0 and 33b0 in the direction of the Z axis is the same as the first embodiment. However, it is preferable that the position of the protrusions 80a and 80b are formed contiguous the protrusions 33a0 and 33b0. The slope sides 80a1 and 80b1 may not necessarily be flat. They can be curved surface as long as they help the insertion of the magnetic rings 10, 11, 20 and 21 easier. The other sides of the protrusions 80a and 80b are not necessarily flat that the edge line can be rounded off which is preferable for the purpose of molding the neck portion 3. The number of the protrusions 80a and 80b is not limited to two which is same as the number of the upper holding portions 33a and 33b in this embodiment. There can be more than two protrusions 80a and 80b formed in the neck portion 3.

[Second Embodiment]

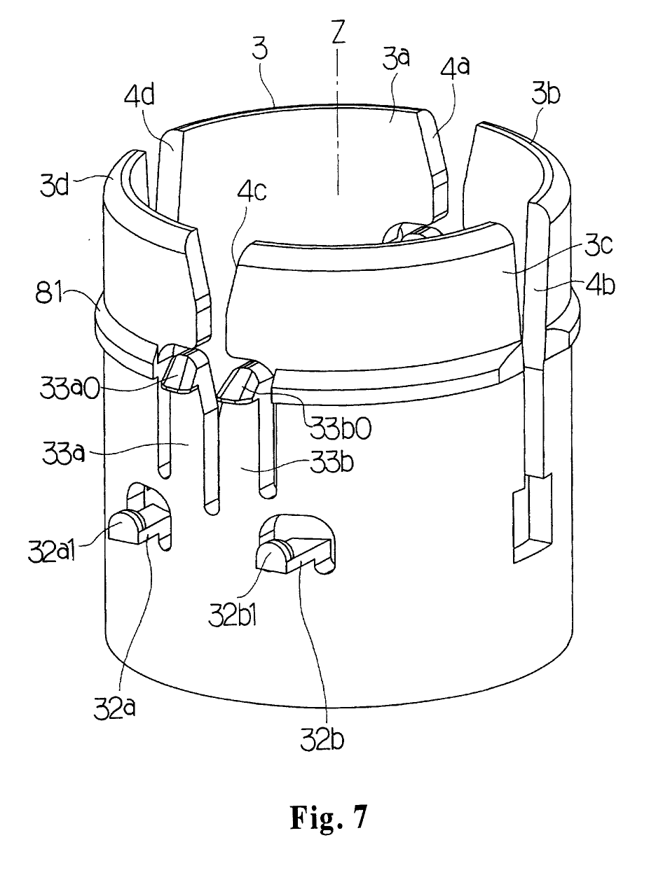

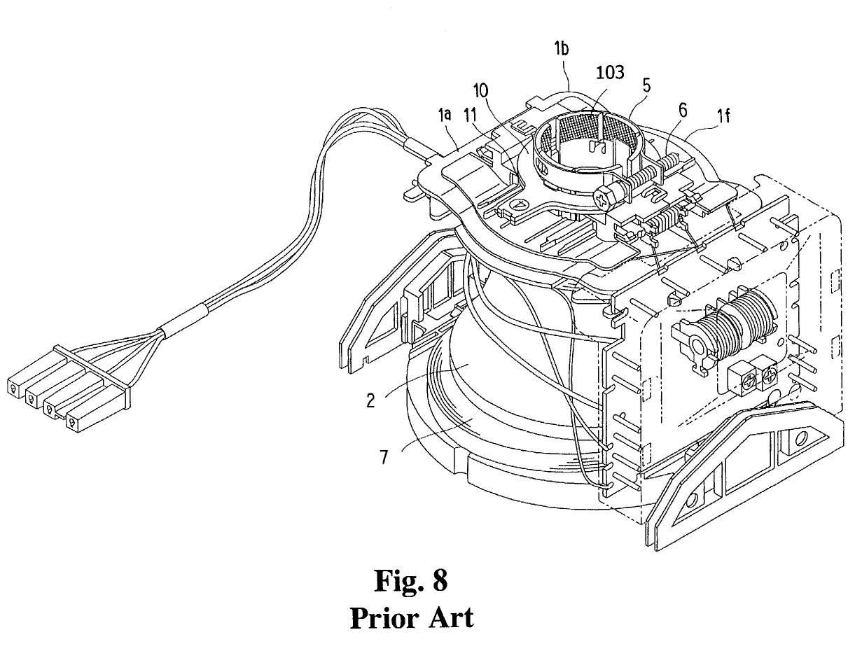

FIG. 7 is a partial perspective view of a substantial portion of a deflection yoke for second embodiment according to the present invention. In FIG. 7, a circular protrusion 81 is formed on the neck portion 3 in the direction of circumference. The circular protrusion 81 is equivalent to the protrusions 80a and 80b shown in FIG. 3 formed continuously around the neck portion 3. In this sense, the cross-sectional view of the circular protrusion 81 in the direction parallel to the Z axis is the same as the cross-sectional view of the protrusion 80a or protrusion 80b in the direction parallel to the Z axis. Although it is not shown, the protrusion can also be an arc shape.

The first embodiment above describes that the upper holding portions 33a and 33b, and the holding portions 32a and 32b are formed in two pairs in one side of the neck portion 3 but there can be only one pair of the upper holding portion and the holding portion. The magnetic rings 10, 11, 20 and 21 to be inserted on the neck portion 3 are not limited to be four (4) and could be more or less. The present invention is not limited to the above embodiments and can be modified within the scope of the purpose of the present invention.

According to an aspect of the present invention, there provided a deflection yoke having a protrusion on a neck portion of the deflection yoke where such protrusion has a slope surface decline to the outer direction from the narrower diameter side to the wider diameter side of the deflection yoke, and contacts a magnetic ring being inserted to the neck portion from the narrower diameter side before the magnetic ring contacts holding portion, and the magnetic ring is held by the holding portion wherein the magnetic ring contacts a second protrusion and the holding portion, and the second protrusion is formed between a first protrusion to stable a clamp band and the holding portion formed on the neck portion, to easily insert the magnetic ring on the neck portion and to avoid the magnetic ring from being damaged.

What is claimed is:

1. A deflection yoke apparatus comprising:
neck portion in a cylindrical shape formed on a subterminal portion of a funnel shaped separator having a narrower diameter portion and a wider diameter portion;
magnetic ring means rotatably mounted on said neck portion;
holding portion means having holding portion for holding said magnetic ring means from said narrower diameter portion side; and
protrusion means formed on said neck portion having a first slope surface decline to the outer direction from said narrower diameter portion side to said wider diameter portion side of said neck portion, wherein said magnetic ring means contacts said first slope surface before contacting said holding portion when said magnetic ring is inserted to said neck portion from said narrower diameter portion side, and said protrusion means leads said magnetic ring means to said holding portion means.

2. The deflection yoke apparatus as claimed in claim 1, wherein said holding portion means has a second slope surface decline to the outer direction from said narrower diameter portion side to said wider diameter portion side of said neck portion, and said first slope surface of said protrusion means leads said magnetic ring means to said second slope surface of said holding portion means.

3. A deflection yoke apparatus comprising:
neck portion having a cylindrical shape and formed on a subterminal portion of a funnel shaped separator with a narrower diameter portion and a wider diameter portion;
first protrusion means formed on said neck portion;
clamp band means having a hole to fit with said first protrusion, for being attached to and for tightening up said neck portion;
magnetic ring means rotatably mounted on said wider diameter portion side of said neck portion than the position of said clamp band being attached to said neck portion;
holding portion means for holding said magnetic ring means from said narrower portion side; and
second protrusion means having a slope surface decline to the outer direction from said narrower diameter portion side to said wider diameter portion side of said neck portion, and formed on said neck portion between said first protrusion means and said holding portion, wherein said magnetic ring means being inserted to said neck portion contacts said slope surface before contacting said holding portion.
